(19) United States
(12) Patent Application Publication
(10) Pub. No.: US 2026/0191739 A1
(43) Pub. Date: Jul. 9, 2026

(54) FIXING JIG

(71) Applicant: NIPRO CORPORATION, Osaka (JP)

(72) Inventors: Tatsuya KUDO, Osaka (JP); Kazuki MATSUMOTO, Osaka (JP); Hiroki YOKOTA, Osaka (JP)

(21) Appl. No.: 19/125,877

(22) PCT Filed: Nov. 9, 2023
(86) PCT No.: PCT/JP2023/040359

§ 371 Date: Apr. 30, 2025

(30) Foreign Application Priority Data
Nov. 10, 2022 (JP) 2022-180016

(51) Int. Cl. A61J 1/16; A61J 1/10; A61J 1/14

(52) U.S. Cl. CPC A61J 1/16; A61J 1/1462; A61J 1/10

(57) ABSTRACT

A fixing jig has a frame body that is capable of holding a bag. The frame body has engagement parts which engage engagement claws of a bottle needle being connected to a discharge port of the bag and which are for maintaining a connection state with the bottle needle The fixing jig which is fixed to the discharge port made of a soft material comprises: first engagement parts that are made of a material harder than the material of the discharge port that can be attached to the discharge port and that are capable of engaging, when attaching the discharge port thereto, a first counter engagement part which is formed in the discharge port; and second engagement parts which are capable of engaging second counter engagement parts formed in the bottle needle. The bottle needle is prevented from slipping off of the discharge port via the first engagement parts and the second engagement parts.

### DESCRIPTION

### Technical Field

The present disclosure relates to a fixing jig for holding a medical bag.

### Background Art

There are various forms of medical bags, and freezer bags for freezing and storing blood, rare cells, biological tissues and the like, and blood bags for separating blood and blood components, and the like are known. As with infusion containers (infusion bags), the various medical bags described above are also increasingly being used in infusion.

Patent Literature 1 describes a connection structure in which engagement claws of a bottle needle (puncture needle) engage with an enlarged diameter portion of a female connector (discharge port) of an infusion container.

### CITATION LIST

### Patent Literature

PATENT LITERATURE 1: Japanese Unexamined Patent Application Publication No. 2017-153729

### SUMMARY

### Technical Problem

The area of an engagement portion of the enlarged diameter portion of the female connector (discharge port) described in Patent Literature 1 differs depending on the infusion container, and the engagement claw may be disengaged by external forces, especially when the engagement area is small. When the bottle needle is removed from the female connector (discharge port), the fluid in the infusion container leaks out.

In particular, for a bag having a discharge port in which a separation wall is formed integrally with a tubular inner portion, the discharge port needs to be made of a soft material in order to penetrate the separation wall with the bottle needle. For a freezer bag for freeze-preservation, the discharge port also needs to be made of a soft material to prevent damage during freezing, and connector detachment is likely to be a problem for such a soft discharge port. In a puncture process of the bottle needle into the discharge port, it is difficult to accurately move the bottle needle horizontally to the discharge port without shaking due to the puncture operation. During the puncture process, a load may be applied to the engagement portion of the discharge port, resulting in minute deformation. As a result, the strength of engagement with the engagement claw drops, and the bottle needle is removed from the discharge port.

Moreover, in a case where the infusion container is a flexible bag, the user tries to grasp the port, but because the port is small, it is difficult to hold and difficult to perform the puncture operation. A bag with a large graspable area could be used, but the external force on the bag may be applied to the liquid in the container, and the liquid in the bag may leak out during puncture.

Advantages of the present disclosure are to solve at least one of the above problems, and to provide a fixing jig that prevents liquid leakage from a discharge port.

### Solution to Problem

A fixing jig according to the present disclosure comprises a frame body capable of holding a bag. The frame body has an engagement portion that engages with a bottle needle connected to the discharge port and maintains a connected state of the bottle needle.

According to the above configuration, since the engagement portion of the frame body holding the bag engages with the bottle needle, the bottle needle connected to the discharge port may be prevented from coming off. Moreover, since the user can hold the frame body instead of the bag during engagement, stability of the operation increases.

The frame body of the fixing jig which is one aspect of the present disclosure may further include a hanging portion.

According to the above configuration, since the fixing jig has the hanging portion, the fixing jig is easily hung on a stand while holding the bag.

The frame body of the fixing jig which is one aspect of the present disclosure may include an opening portion that exposes the bag.

According to the above configuration, the amount of liquid in the bag may be easily confirmed through the opening portion.

The fixing jig which is one aspect of the present disclosure may include the frame body configured to be openable and closable, and a locking structure that maintains a state of closing the frame body and holding the bag.

According to the above configuration, the frame body does not open easily, and the held bag may be prevented from falling.

The frame body of the fixing jig which is one aspect of the present disclosure may include over insertion prevention means that prevents excessive insertion of the bottle needle by abutting with a part of the bottle needle when the bottle needle is inserted into the discharge port.

According to the above configuration, over insertion of the bottle needle into the discharge port may be prevented.

A fixing jig according to the present disclosure is a fixing jig attached to a discharge port in which a separation wall is formed integrally with a tubular inner portion or a discharge port provided in a freezer bag for freeze-preservation, the fixing jig including a first engagement portion that is formed to be harder than the discharge port, is attachable to the discharge port, and is capable of engaging with a first engaged portion formed in the discharge port during attachment, and a second engagement portion that is capable of engaging with a second engaged portion formed in the bottle needle, in which the bottle needle is prevented from coming off the discharge port by the first engagement portion and the second engagement portion.

According to the above configuration, a process of engaging the engagement member with the discharge port and the puncture operation of the bottle needle may be separated, so that applying a load on the engaged portion of the discharged port and deforming it may be avoided. Moreover, when the fixing jig attached to the discharge port is harder than the discharge port, since the hard fixing jig has the engagement portion with the bottle needle, engagement with the bottle needle may be made stable, and removal of the bottle needle connected to the discharge port may be prevented.

The fixing jig which is one aspect of the present disclosure may be configured to be openable and closable, and include a locking structure that closes the frame body and holds the discharge port. Since the fixing jig is openable and closable, applying a load on the engaged portion when engaging with the discharge port may be avoided more reliably.

### Advantageous Effect of Invention

According to the fixing jig of the present disclosure, it is possible to prevent a bottle needle connected to a discharge port from coming off.

### BRIEF DESCRIPTION OF DRAWING

FIG. 1 is a perspective view of a fixing jig, a bag, and a bottle needle of an embodiment.

FIG. 2 is a perspective view of the fixing jig of the embodiment in a closed state.

FIG. 3 is a view of a state where the bottle needle is connected to the fixing jig of the embodiment holding the bag.

FIG. 4 is a perspective view of an A-A cross section of FIG. 3.

FIG. 5 is a view for describing how the bag is housed in the fixing jig of the embodiment, and is a view of a state where the fixing jig is open.

FIG. 6 is a view for describing how the bag is housed in the fixing jig of the embodiment, and is a view of a state where the fixing jig is closed.

FIG. 7A is a perspective view of a state where a fixing jig of a second embodiment is open.

FIG. 7B is a perspective view for describing a state of a bag before use.

FIG. 8 is a view of a state where a bottle needle is connected to the fixing jig of the second embodiment holding the bag.

FIG. 9 is a cross-sectional view of the fixing jig of the second embodiment corresponding to FIG. 4.

### DESCRIPTION OF EMBODIMENTS

Hereinafter, embodiments of the present disclosure will be described in detail with reference to the drawings. In the following description, specific shapes, materials, directions, numerical values, and the like are examples for facilitating understanding of the present disclosure, and can be changed as necessary to suit the application, purpose, specification, and the like. It is also envisioned from the outset that the components of the embodiments and modifications described below may be selectively combined.

First, configurations of a bag 50 and a bottle needle 60 used in a fixing jig 10 of the embodiment of the present disclosure will be described.

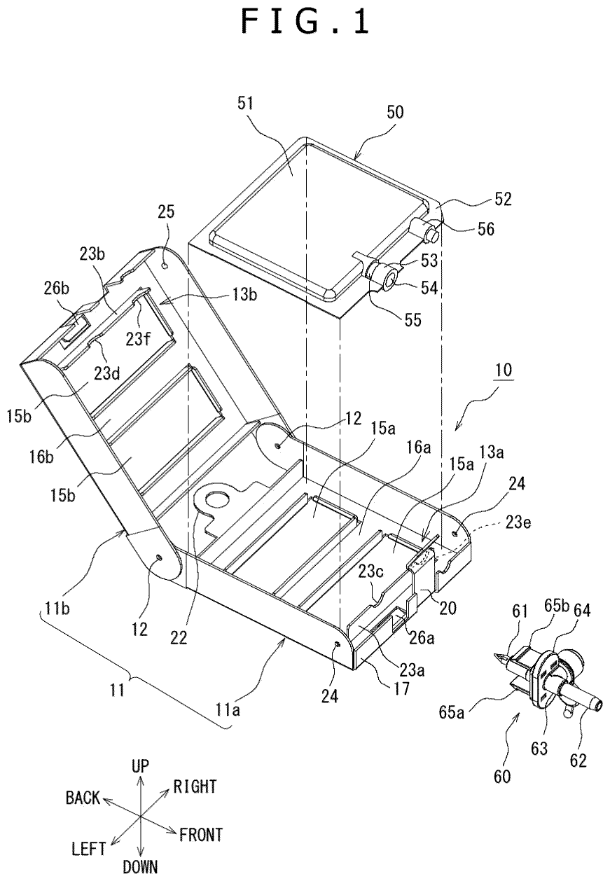

As illustrated in FIG. 1, the bag 50 has a rectangular flat bag shape. The bag 50 is formed by laminating two rectangular films together, and has a body portion 51 that stores a content, and a joint portion 52 that projects around the body portion 51. The bag 50 is formed in the shape of a bag that seals an internal space of the body portion 51 by the joint portion 52 surrounding the body portion 51. The body portion 51 stores blood, rare cells, drugs, or biological tissues, for example.

The bag 50 has a discharge port 53 protruding from an end of the body portion 51. The discharge port 53 has a hollow tube shape connected to the internal space of the body portion 51, and its tip end 54 or tubular inner portion is closed by a separation wall. The discharge port 53 is used by inserting the bottle needle 60 through the tip end 54 and connecting it to the body portion 51 when taking out an internal solution.

The discharge port 53 has, on its circumference, a reduced diameter portion 55 between the body portion 51 and the tip end 54. As will be described later, when the bag 50 is accommodated in the fixing jig 10, the reduced diameter portion 55 is held by recesses 23c, 23d provided in the fixing jig 10 to prevent the bag 50 from moving.

The bag 50 has a filler port 56 adjacent to the discharge port 53 and connected to the inside of the body portion 51. The filler port 56 is used when injecting blood, rare cells, biological tissues, and the like into the body portion 51.

Next, the bottle needle 60 will be described. The bottle needle 60 has an elongated hollow tubular shape. The bottle needle 60 has a pointed tip end portion 61 at one end, a torso portion 63 extending in the axial direction, and a male connector portion 62 at the other end, and has, in the torso portion 63, a flange portion 64 that extends perpendicular to the axial direction. The tip end portion 61, male connector portion 62, torso portion 63, and flange portion 64 of the bottle needle 60 are integrally made of resin, such as acrylonitrile butadiene styrene (ABS) resin.

The bottle needle 60 has engagement claws 65a, 65b extending in the direction of the tip end portion 61 from the flange portion 64. The engagement claws 65a, 65b are for engagement with engagement portions 26a, 26b of the fixing jig 10 when the bottle needle 60 is connected to the discharge port 53 as described later. The engagement claws 65a, 65b are formed of polyoxymethylene (POM), for example.

### First Embodiment

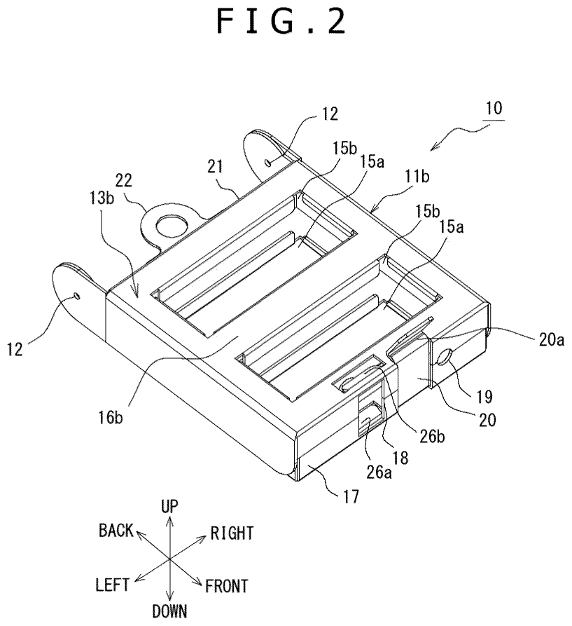

Referring to FIGS. 1 and 2, a fixing jig 10 of a first embodiment of the present disclosure will be described. FIG. 1 is a perspective view illustrating the appearance of the fixing jig 10, a bag 50, and a bottle needle 60 illustrating a state where the fixing jig 10 is open. FIG. 2 is a perspective view of a state where the fixing jig 10 is closed. In the following description, directions such as up and down, left and right, and front and back are used only for convenience of explanation and are not intended to define the direction of use of the fixing jig 10 according to the embodiment.

The fixing jig 10 comprises a frame body 11 that holds the bag 50. The frame body 11 is larger than the bag 50, and includes therein a space that can accommodate the bag 50. The frame body 11 can cover the entire bag 50 including the body portion 51, the joint portion 52, and the discharge port 53. Then, the frame body 11 can hold the bag 50 by sandwiching the bag 50 from both sides in the thickness direction. While the frame body 11 is a frame body made of metal such as aluminum, it is not limited to metal, and may be made of a harder resin than the discharge port 53.

The frame body 11 has a first frame body 11a, a second frame body 11b, and a hinge portion 12. The frame body 11 has a structure in which the first frame body 11a and the second frame body 11b are openably coupled via the hinge portion 12. The bag 50 can be placed on the first frame body 11a or the second frame body 11b with the frame body 11 open, and the bag 50 is accommodated inside the frame body 11 by closing the frame body 11.

The frame body 11 has the engagement portions 26a, 26b that, while holding the bag 50, engage with the engagement claws 65a, 65b of the bottle needle 60 connected to the discharge port 53 of the bag 50 and hold the connected state between the discharge port 53 and the bottle needle 60.

The frame body 11 further includes a locking structure for maintaining the closed state of the first frame body 11a and the second frame body 11b. The locking structure prevents the frame body 11 from opening easily and dropping the held bag 50.

Next, details of the frame body 11, the first frame body 11a, and the second frame body 11b will be described.

The first frame body 11a and the second frame body 11b have rectangular base portions 13a, 13b, respectively, and have a wall surrounding them. The frame body 11 forms a box shape as illustrated in FIG. 2 when the first frame body 11a and the second frame body 11b are closed, and can accommodate the bag 50 inside it.

The frame body 11 has, in the base portions 13a, 13b of the first frame body 11a and the second frame body 11b, opening portions 15a, 15b that expose the bag 50, so that the inside of the closed frame body 11 can be viewed. The frame body 11 further includes beam portions 16a, 16b formed to compartmentalize the opening portions 15a, 15b. The beam portions 16a, 16b can prevent the user from pressing directly on the body of the bag 50 with the fingers when gripping the fixing jig 10.

As illustrated in FIG. 2, a discharge port connection opening 18, a filler port connection opening 19, and a hook 20 are formed on a front wall 17 of the closed frame body 11.

The discharge port connection opening 18 is an opening for connecting the bottle needle 60 to the discharge port 53 with the bag 50 accommodated in the frame body 11.

Similarly, the filler port connection opening 19 is configured to enable access to the filler port 56 with the bag 50 accommodated in the frame body 11.

The hook 20 forms a locking structure for maintaining the closed state of the frame body 11. The hook 20 has a tip end portion 20a bent toward the inside of the frame body 11. When closing the frame body 11, the tip end portion 20a deforms elastically in the front-rear direction along the front wall 17, and the tip end portion 20a is fixed by elastic return when it goes over the base portion 13b. With this configuration, the tip end portion 20a is hooked to the base portion 13b of the second frame body 11b with the frame body 11 closed, and the closed state of the frame body 11 can be maintained.

A hanging portion 22 is provided on a back wall 21 of the frame body 11. The hanging portion 22 is used for hanging the fixing jig 10 on a stand or the like while holding the bag 50. While the hanging portion 22 is formed in the first frame body 11a in the fixing jig 10 of FIG. 1, it may be formed in the second frame body 11b.

Next, a holding structure of the bag 50 inside the frame body 11 will be described further with reference to FIG. 1.

Edges of the opening portions 15a, 15b provided in the first frame body 11a and the second frame body 11b are bent inward. When the frame body 11 is closed with the bag 50 accommodated therein, the bent edges of the respective opening portions 15a, 15b of the first frame body 11a and the second frame body 11b sandwich the body portion 51 of the bag 50.

The first frame body 11a and the second frame body 11b have discharge port support plates 23a, 23b, respectively, on the front wall 17 side along the edges of the opening portions 15a, 15b. The discharge port support plates 23a, 23b are formed to sandwich the discharge port 53, the filler port 56, and the joint portion 52 of the bag 50 when the frame body 11 is closed.

The recesses 23c, 23d are formed in end portions of the discharge port support plates 23a, 23b of the first frame body 11a and the second frame body 11b, respectively. The recesses 23c, 23d are formed to sandwich the reduced diameter portion 55 of the discharge port 53 when the frame body 11 is closed to sandwich the bag 50. By sandwiching the reduced diameter portion 55 by the recesses 23c, 23d, the bag 50 can be held in place without moving.

Recesses 23e, 23f are further provided in the end portions of the discharge port support plates 23a, 23b. The recesses 23e, 23f are provided in positions where they come into contact with the filler port 56 when the frame body 11 is closed to sandwich the filler port 56.

In the fixing jig 10 of FIG. 1, the frame body 11 has a locking structure for maintaining the closed state in addition to the aforementioned hook 20. A locking hole 24 is formed in a side wall of the first frame body 11a, and a locking projection 25 is formed in a side wall of the second frame body 11b. When the frame body 11 is closed, the locking projection 25 fits into the locking hole 24 and the locked state of the frame body 11 is maintained.

The first frame body 11a and the second frame body 11b are provided with the engagement portions 26a, 26b between the discharge port connection opening 18 and the discharge port support plates 23a, 23b. By thus providing the engagement portions 26a, 26b, the bottle needle 60 is connected to the fixing jig 10 sandwiching the bag 50, and at the same time, the engagement claws 65a, 65b are engaged with the engagement portions 26a, 26b to prevent the bottle needle 60 from being detached from the fixing jig 10.

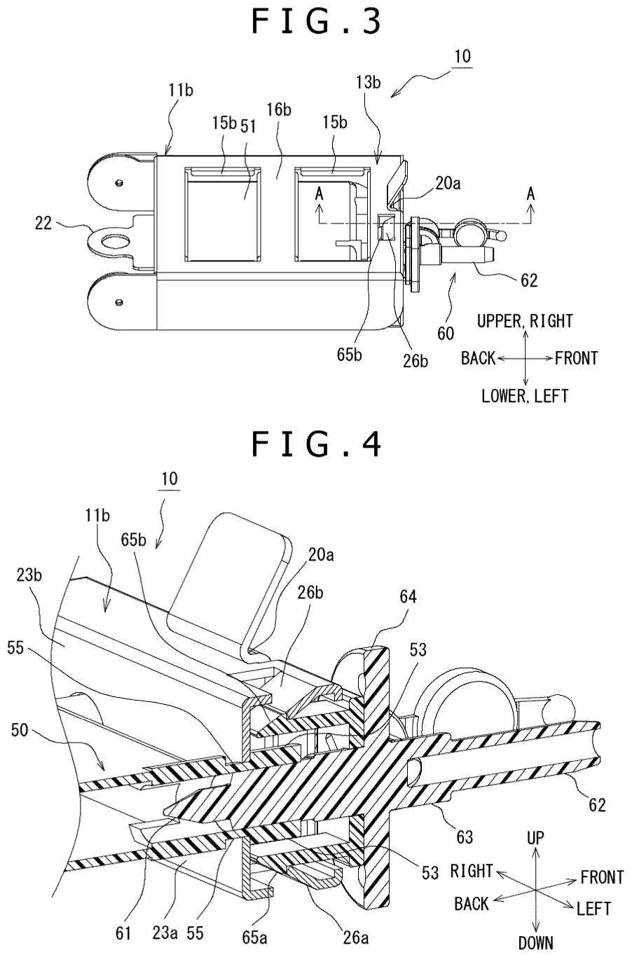

Next, an engagement structure of the bottle needle 60 in the fixing jig 10 will be described with reference to FIGS. 3 and 4.

FIG. 3 illustrates a state where the bottle needle 60 is inserted to a predetermined position of the fixing jig 10 holding the bag 50. In this state, the engagement claws 65a, 65b of the bottle needle 60 engage with the engagement portions 26a, 26b of the fixing jig 10 and are fixed so as not to come off.

FIG. 4 is a perspective view of an A-A cross section of FIG. 3. FIG. 4 illustrates a state where the tip end portion 61 and a part of the torso portion 63 of the bottle needle 60 are inserted into the discharge port 53 of the bag 50. The engagement claws 65a, 65b of the bottle needle 60 engage with the engagement portions 26a, 26b, and the bottle needle 60 is restricted from moving in the front-rear direction. The fixing jig 10 is formed so that insertion of the bottle needle 60 into the discharge port 53 is at an appropriate depth when the engagement claws 65a, 65b are inserted to the position of engagement with the engagement portions 26a, 26b.

The engagement portion 26a of the first frame body 11a is bent toward the inside (upper side) of the fixing jig 10. Similarly, the engagement portion 26b of the second frame body 11b is bent toward the inside (lower side) of the fixing jig 10. The tip end of the engagement portion 26a and the tip end of the engagement portion 26b come into contact with the steps of the engagement claws 65a, 65b, forming a structure that prevents removal of the bottle needle 60 from the fixing jig 10.

In the fixing jig 10 of the present embodiment, positions of the engagement claws 65a, 65b when the bottle needle 60 is inserted are determined by the lengths in the front-rear direction of the engagement portion 26a of the first frame body 11a and the engagement portion 26b of the second frame body 11b. The insertion depth of the bottle needle 60 inserted into the discharge port 53 is determined by the length in the front-rear direction from the front wall 17 to the discharge port support plates 23a, 23b. Accordingly, if these dimensions are designed appropriately, the bottle needle 60 can be inserted to an appropriate depth in the discharge port 53 by pushing the engagement claws 65a, 65b into the engagement portions 26a, 26b until they are hooked onto the engagement portions 26a, 26b.

The engagement portion 26a of the first frame body 11a and the engagement portion 26b of the second frame body 11b extend obliquely so that their tip ends come close to each other in the vertical direction. Therefore, the distance in the vertical direction between the tip end of the engagement portion 26a and the tip end of the engagement portion 26b is narrower than the maximum distance in the vertical direction between the projecting engagement claws 65a, 65b. With this configuration, when the bottle needle 60 is inserted from the discharge port connection opening 18, the inclined portions of the tip ends of the engagement claws 65a, 65b abut on the tip ends of the engagement portions 26a, 26b, and the engagement claws 65a, 65b are inserted while deforming inward in the vertical direction. When portions of the engagement claws 65a, 65b separated at the maximum distance go over the tip ends of the engagement portions 26a, 26b, the shapes of the deformed engagement claws 65a, 65b are restored (elastic return), and horizontally parallel plate portions of the engagement claws 65a, 65b abut on the tip ends of the engagement portions 26a, 26b. When the horizontally parallel plate portions of the engagement claws 65a, 65b abut on the tip ends of the engagement portions 26a, 26b, the vibration is transmitted to the hand holding the flange portion 64 to confirm that the bottle needle 60 is inserted with an appropriate length. Although it depends on the material, the sound of the horizontally parallel plate portions of the engagement claws 65a, 65b hitting the tip end of the engagement portions 26a, 26b can also confirm that the bottle needle 60 has been inserted to the appropriate depth.

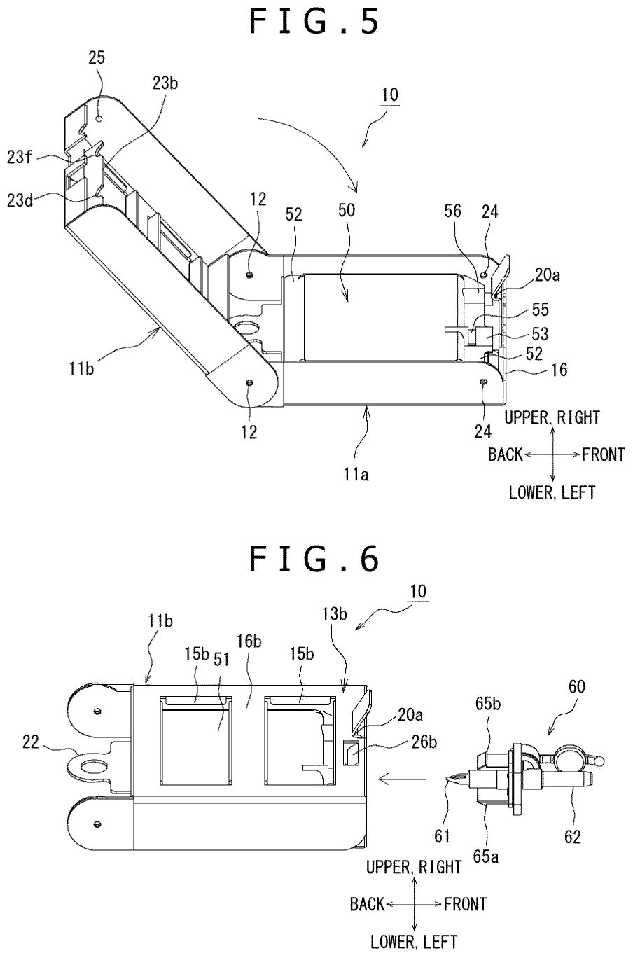

Referring to FIGS. 5 and 6, a method of accommodating the bag 50 in the fixing jig 10 of the present embodiment and attaching the bottle needle 60 thereto will be described.

FIG. 5 is a view of a state where the first frame body 11a and the second frame body 11b of the fixing jig 10 are opened. The bag 50 is accommodated in the first frame body 11a, so that the reduced diameter portion 55 of the discharge port 53 fits into left recess 23c (see FIG. 1) of the discharge port support plate 23a of the first frame body 11a, and the filler port 56 is placed on the right recess 23e. In this state, the second frame body 11b is moved in the arrow direction in FIG. 5 about the axis of the hinge portion 12, to sandwich the reduced diameter portion 55 of the discharge port 53 with the recesses 23c and 23d, to sandwich the filler port 56 with the recesses 23e and 23f, and to close the frame body 11. In the closed state of the frame body 11, the locking projection 25 of the second frame body 11b fits into the locking hole 24 of the first frame body 11a, and the tip end portion 20a of the hook 20 is hooked onto the base portion 13b of the second frame body 11b, whereby the bag 50 is held in the frame body 11 (FIG. 6). Since the frame body 11 is configured to be openable, less load is applied on the reduced diameter portion 55 of the discharge port 53 when sandwiching the reduced diameter portion 55 by the recesses 23c, 23d. This suppresses deformation of the reduced diameter portion 55, which is the engaged portion with the recesses 23c, 23d, and improves stability when inserting the bottle needle 60.

In the state illustrated in FIG. 6, the bag 50 is held by the discharge port support plate 23a of the first frame body 11a and the discharge port support plate 23b of the second frame body 11b. In this state, the two engagement claws 65a, 65b of the bottle needle 60 arranged in the vertical direction connect the bottle needle 60 from the discharge port connection opening 18 of the fixing jig 10. By pushing the engagement claws 65a, 65b of the bottle needle 60 into the discharge port connection opening 18 along the engagement portions 26a, 26b, the bottle needle 60 can be inserted into the discharge port 53 horizontally. As described above, since the reduced diameter portion 55 of the discharge port 53 is sandwiched by the recesses 23c, 23d, the bag 50 and the discharge port 53 are held without moving when the tip end portion 61 of the bottle needle 60 is inserted into the discharge port 53.

As illustrated in FIG. 6, the body portion 51 of the bag 50 can be seen from the opening portion 15b and the opening portion 15a on the opposite side. When the bag 50 is used for an intravenous drip, the amount of liquid in the bag 50 can be confirmed through the opening portions 15a, 15b. It is also possible to check whether the bag 50 is arranged properly. Moreover, when the bag 50 is a freezer bag and there is frozen residue in the bag 50, it can be sent out without leaving any liquid by squeezing the bag 50 from the opening portions 15a, 15b. The beam portions 16a, 16b between the opening portions 15a, 15b have a role of maintaining strength of the second frame body 11b, and also have a role of preventing the fingers from pressing directly on the body portion 51 of the bag 50 when handling the fixing jig 10 with the hand.

As described above, according to the fixing jig 10 of the present embodiment, the engagement portions 26a, 26b of the frame body 11 holding the bag 50 engage with the engagement claws 65a, 65b of the bottle needle 60, so that it is possible to prevent the bottle needle 60 connected to the discharge port 53 from being removed.

As illustrated in FIGS. 1 and 6, the fixing jig 10 of the present embodiment is provided with the hanging portion 22 provided integrally with the back wall 21 of the first frame body 11a. Since the hanging portion 22 is formed integrally with the fixing jig 10, the fixing jig 10 holding the bag 50 can be easily hung on a stand or the like. While the hanging portion 22 is disposed in a center portion of the back wall 21 in FIGS. 1 and 6, the location is not limited to this. Any arrangement can be adopted as long as it is configured such that the components of the bag 50 flow toward the male connector portion 62 of the bottle needle 60 when hung on a stand.

As illustrated in FIGS. 1 and 6, the fixing jig 10 of the present embodiment further includes the hook 20. When the bag 50 is held, the hook 20 prevents the first frame body 11a and second frame body 11b from opening easily. The hook 20 prevents the fixing jig 10 from opening easily when the fixing jig 10 is hung, thus preventing the bag 50 from falling.

In the above embodiment, the hinge portion 12 is disposed at the back of side walls of the first frame body 11a and the second frame body 11b. Accordingly, the first frame body 11a and the second frame body 11b are opened and closed by opening the front side with the hinge portion 12 as the axis. However, the opening and closing direction of the first frame body 11a and the second frame body 11b is not limited to this. The hinge portion 12 may be disposed at the front of the side walls and the back side may be opened. With this configuration, the bag 50 can be prevented from falling easily even when the first frame body 11a and the second frame body 11b are not closed. Alternatively, the first frame body 11a and the second frame body 11b may open to the left and right. The configuration of the hinge is a well-known configuration, and various modifications can be made. Moreover, the first frame body 11a and the second frame body 11b may be two members not coupled with a hinge.

In the above embodiment, the hinge portion 12 protrudes to the back of the side walls of the first frame body 11a and the second frame body 11b, so that the hanging portion 22 does not come into contact with the second frame body 11b when opening and closing. However, the hinge portion 12 does not necessarily have to protrude if the bag 50 can be disposed in the fixing jig 10, and the second frame body 11b may come into contact with the hanging portion 22 when opening and closing.

While the beam portions 16a, 16b of the first frame body 11a and the second frame body 11b compartmentalize the opening portions 15a, 15b in the above embodiment, the width, location, and number of the beam portions 16a, 16b are not limited to those in the embodiment. Therefore, there may be two or more beam portions 16a, 16b, and the size of the compartmentalized opening portions 15a, 15b does not have to be equal. The beam portions 16a, 16b may be omitted. It is only necessary to view the amount of liquid and arrangement of the bag 50 through the opening portions 15a, 15b when the bag 50 is used as an intravenous drip. When the bag 50 is a freezer bag and there is frozen residue, the bag 50 only needs to be squeezable and is not limited to the above configurations and drawings.

In the above embodiment, when the fixing jig 10 is closed, the bag 50 is surrounded by the side walls of the first frame body 11a and the second frame body 11b and the back wall 17. This makes it easier to position the bag 50 and reduces the risk of accidentally touching the bag 50. However, the wall of the fixing jig 10 is not always necessary. If there is no wall, visibility from the side surface increases and the arrangement of the bag 50 can be confirmed from many angles.

Additionally, the fixing jig 10 does not necessarily have to hold the entire bag 50, and may hold only a part of the bag 50, or may hold only the discharge port 53. Specifically, any configuration can be adopted as long as the reduced diameter portion (first engaged portion) 55 of the discharge port 53 is sandwiched and held by the recesses (first engagement portion) 23c, 23d of the discharge port support plates 23a, 23b, and the engagement portions (second engagement portion) 26a, 26b of the frame body 11 engage with the engagement claws (second engaged portion) 65a, 65b of the bottle needle 60. Since the fixing jig 10 is made of a harder material than the discharge port 53, when the discharge port 53 is attached, the recesses (first engagement portion) 23c, 23d of the discharge port support plates 23a, 23b and the engagement portions (second engagement portion) 26a, 26b can prevent the bottle needle 60 from coming off the discharge port 53.

While the edges of the opening portions 15a, 15b and the discharge port support plates 23a, 23b are formed continuously over the entire opening of the opening portions 15a, 15b in the above embodiment, such a configuration is not always necessary. That is, as long as the bag 50 is held and the reduced diameter portion 55 of the discharge port 53 and the filler port 56 can be fixed, the edges and discharge port support plates 23a, 23b may be formed intermittently.

While the fixing jig 10 fixes the first frame body 11a and the second frame body 11b by fitting of the locking hole 24 and the locking projection 25 and the hooking of the hook 20, such a configuration is not always necessary. Not limited to the above embodiment, any one of the locking structures may be adopted, or another locking structure other than the locking hole 24 and locking projection 25 and the hook 20 may be added as needed.

### Second Embodiment

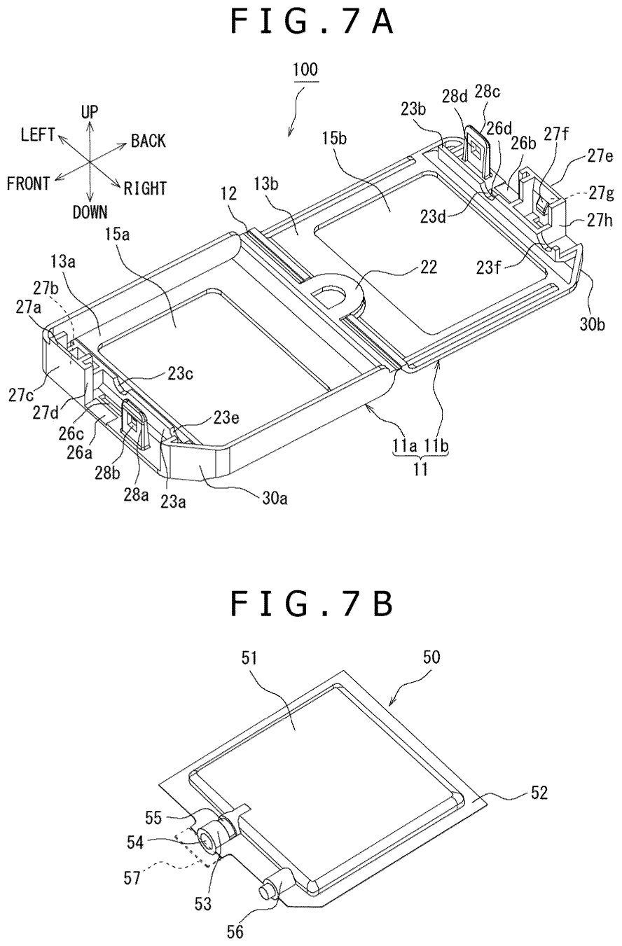

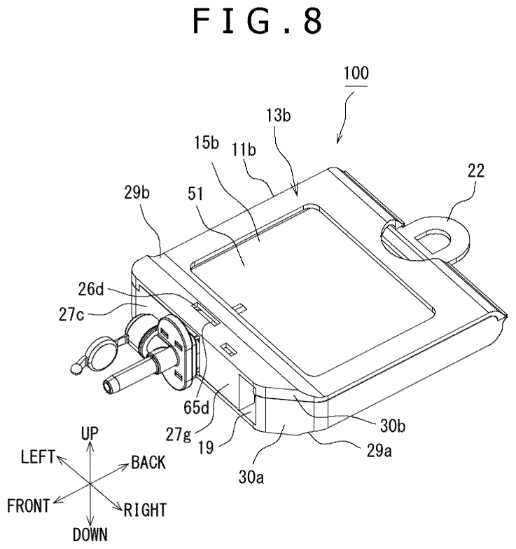

Referring to FIGS. 7A, 7B, and 8, a fixing jig 100 of a second embodiment of the present disclosure will be described. In the second embodiment, components similar to the components in the first embodiment are assigned the same reference numerals and detailed descriptions are omitted.

The fixing jig 100 of the second embodiment is formed integrally by a harder resin material than a discharge port 53, such as polypropylene. By using resin, the fixing jig 100 can be made more compact and lighter than the fixing jig 10 of the first embodiment. Integral formation with resin facilitates manufacturing. Details will be described below.

As in the first embodiment, a frame body 11 of the second embodiment has a first frame body 11a and a second frame body 11b. The first frame body 11a has a base portion 13a, and has an opening portion 15a in the base portion 13a. Similarly, the second frame body 11b has a base portion 13b, and has an opening portion 15b. There is no beam portion in the opening portion 15a of the first frame body 11a and the opening portion 15b of the second frame body 11b of the second embodiment. This is because while the frame body 11 made of resin is more compact and easily held without touching a part where a beam portion can be provided with the fingers, since the opening portions 15a, 15b are smaller, providing a beam portion deteriorates the visibility of the bag 50. However, as has been mentioned in the first embodiment, whether or not to provide the beam portion is not particularly limited, and it may be provided according to need.

The first frame body 11a similarly includes a hanging portion 22. The purpose of the hanging portion 22 is similar to the purpose in the first embodiment, and the hanging portion 22 may be provided in the second frame body 11b.

A discharge port support plate 23a is formed in front of the opening portion 15a of the first frame body 11a, and a discharge port support plate 23b is formed in a corresponding portion of the second frame body 11b. Two recesses 23c, 23d are formed in the discharge port support plates 23a, 23b. The recesses 23c, 23d are configured to sandwich a reduced diameter portion 55 of a bag 50 as in the first embodiment. Also, recesses 23e, 23f are further formed in end portions of the discharge port support plates 23a, 23b to sandwich a filler port 56, as in the first embodiment. As long as the discharge port support plates 23a, 23b include the recesses 23c, 23d, 23e, 23f, the discharge port support plates 23a, 23b do not have to be continuous, and may be provided only around the recesses.

The configuration described above has a similar configuration and role as the first embodiment.

Next, a configuration specific to the fixing jig 100 of the second embodiment will be described.

In the fixing jig 100 of the second embodiment, the frame body 11 is formed integrally by a resin material. The first frame body 11a and the second frame body 11b are connected by a hinge portion 12. By providing the hinge portion 12, the first frame body 11a and the second frame body 11b can rotate, hold the bag 50 while accommodating it in a base portion 13a and a base portion 13b, and be closed. In the present embodiment, too, the frame body 11 is configured to be openable, so that less load is applied on the reduced diameter portion 55 of the discharge port 53 when sandwiching the reduced diameter portion 55 by the recesses 23c, 23d. This suppresses deformation of the reduced diameter portion 55, which is the engaged portion with the recesses 23c, 23d, and improves stability when inserting a bottle needle 60.

As described above, the frame body 11 of the fixing jig 100 is made of resin, and therefore can be made more compact and lighter than the fixing jig 10 of the first embodiment. The fixing jig 100 is easy to carry due to its compactness and lightness.

The fixing jig 100 of the second embodiment has locking claws 27a, 27e and locking windows 28a, 28c at the front edge of the first frame body 11a and the second frame body 11b. The locking claws 27a, 27e and the locking windows 28a, 28c form a locking structure of the fixing jig 100.

As illustrated in FIG. 7A, on the near-side edge, the first frame body 11a has the locking claw 27a at the left end, and an engagement portion 26a, a window portion 26c, and the locking window 28a along the edge, in this order. In a closed state of the frame body 11, the second frame body 11b has, in corresponding portions, the locking window 28c, an engagement portion 26b, a window portion 26d, and the locking claw 27e. The structure of the engagement portions 26a, 26b will be described later.

In the first frame body 11a and the second frame body 11b, the locking claws 27a, 27e and the locking windows 28a, 28c are formed alternately. Since the frame body 11 is made of resin, the locking claws or locking windows may break or deform unexpectedly. Hence, the locking claws and locking windows are formed alternately to prevent the frame body 11 from opening in such a case. Accordingly, the mode is not limited to this, as long as opening of the frame body 11 can be prevented.

The locking claw 27a of the first frame body 11a has a wall portion 27c extending vertically from the edge of the base portion 13a of the first frame body 11a, a claw portion 27b provided at the center of the wall portion 27c, and a side wall portion 27d which is left and right side surfaces of the wall portion 27c. The locking claw 27a fits into the locking window 28c of the second frame body 11b.

The locking window 28c of the second frame body 11b is a plate-shaped member extending vertically from the edge of the base portion 13b of the second frame body 11b, and has a window portion 28d at the substantial center of the plate-shaped portion. The outer shape of the locking window 28c is formed to correspond to the wall portion 27c and the side wall portion 27d of the locking claw 27a. The claw portion 27b of the locking claw 27a is formed to fit into the window portion 28d of the locking window 28c when the frame body 11 is closed.

The locking claw 27e of the second frame body 11b is formed similarly to the locking claw 27a. The locking window 28a of the first frame body 11a is formed similarly to the locking window 28c.

When the frame body 11 is closed, the locking claws 27a, 27e and the locking windows 28a, 28c fit into each other, and do not come off once they are fitted, i.e., they have a fixed fitting structure.

The fixing jig 100 of the present embodiment further comprises a structure for preventing incorrect attachment of the bag 50 before use. FIG. 7B is a diagram for describing a state of the bag 50 before use. In the bag 50 before use, a tip end 54 of a discharge port 53 is protected by a protection sheet 57 indicated by a broken line integrated with a joint portion 52 surrounding a body portion 51.

When using the bag 50, the protection sheet 57 is cut off, and the bag 50 is attached to the fixing jig 100 with the discharge port 53 exposed. Since the fixing jig 100 of the present embodiment adopts the fixed fitting structure as the locking structure, when the bag 50 is attached to the fixing jig 100 with the protection sheet 57 on, the internal solution of the bag 50 cannot be taken out, and will be wasted. Hence, to prevent incorrect attachment, in the fixing jig 100 of the present embodiment, the side wall portion 27d of the locking claw 27a is expanded laterally (to the right). When the bag 50 from which the protection sheet 57 is not cut off is placed on the first frame body 11a, the protection sheet 57 interferes with the side wall portion 27d and prevents the bag 50 from being set on the first frame body 11a. Thus, incorrect attachment of the bag 50 before use can be prevented. In the fixing jig 100 of FIG. 7A, a side wall portion 27h of the locking claw 27e is also expanded laterally (to the left). The side wall portion 27h can similarly interfere with the protection sheet 57 to prevent incorrect attachment. Note that in the structure for preventing incorrect attachment, the expanded portion of the side wall portion 27h may be provided on the first frame body 11a side.

FIG. 8 illustrates a state where the frame body 11 of the fixing jig 100 of the second embodiment is closed to hold the bag 50 and the bottle needle 60 is connected thereto.

The fixing jig 100 of the present embodiment is made of resin, and therefore can be discarded in the state illustrated in FIG. 8 after use of the bag 50. Therefore, the fixed fitting structure is adopted as the locking structure.

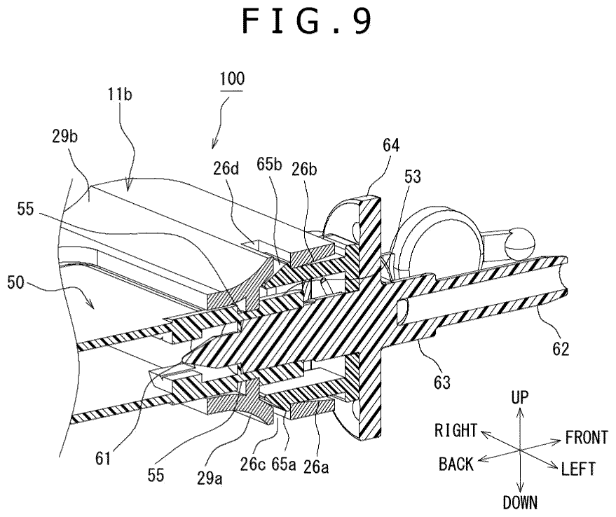

Next, referring to FIGS. 7A, 7B, and 9, an engagement structure of the fixing jig 100 of the second embodiment will be described. FIG. 9 is a view corresponding to FIG. 4 of the first embodiment.

The engagement portions 26a, 26b of the fixing jig 100 of the second embodiment are formed by varying the thickness of an edge portion of the first frame body 11a and the second frame body 11b. The thickness of the engagement portion 26a, 26b is thinnest at the front illustrated in FIG. 9, and is inclined so that the thickness increases toward the back (connection direction of bottle needle 60). As a result, the distance in the vertical direction between the engagement portions 26a, 26b is widest at the front end and gradually narrows toward the back. With this configuration, the bottle needle 60 is connected to the discharge port 53, and horizontally parallel plate portions of the engagement claws 65a, 65b abut on the tip ends of the engagement portions 26a, 26b, so that the bottle needle 60 is prevented from coming off.

In the present embodiment, too, the effect of the engagement claws 65a, 65b of the bottle needle 60 engaging with the engagement portions 26a, 26b and restricting movement of the bottle needle 60 in the front-rear direction is similar to the effect in the first embodiment. Moreover, the effect of the vibration or sound of horizontally parallel portions of the engagement claws 65a, 65b hitting the tip ends of the engagement portions 26a, 26b when the bottle needle 60 is inserted into the discharge port 53 can be used to confirm insertion of the bottle needle 60 to an appropriate depth, and is also similar to the effect of the first embodiment.

Next, referring to FIGS. 8 and 9, finger placement portions 29a, 29b provided in the first frame body 11a and the second frame body 11b will be described. The finger placement portions 29a, 29b have constricted shapes that come close to each other in the vertical direction from the front to the back. This shape allows base portions 13a, 13b of the frame body 11 to be closer to the body portion 51 of the bag 50 in the vertical direction than the edge portions on the near side of the first frame body 11a and second frame body 11b to which the bottle needle 60 is connected, so that the base portions 13a, 13b are in contact with or slightly separated from the body portion 51. Hence, movement of the body portion 51 in the vertical direction while the frame body 11 holds the bag 50 can be restricted, whereby stability in holding the frame body 11 is improved.

The finger placement portions 29a, 29b preferably have a curved shape that extends along the fingers when the fixing jig 100 is held. While the bag 50 can be held by the fixing jig 100 alone, by holding the frame body 11 by gripping with the fingers placed along the finger placement portions 29a, 29b, it is possible to suppress opening of the discharge port support plates 23a, 23b and the reduced diameter portion 55, and operability is improved even more. Incidentally, the finger placement portions 29a, 29b are not limited to the curved shape illustrated in FIGS. 8 and 9. For example, each of the finger placement portions 29a, 29b may be formed as a slope a shape approaching straight up and down from the front to the back, or as a step shape with multiple steps from the front to the back.

Furthermore, the fixing jig 100 of the present embodiment has means to prevent over insertion of the bottle needle. When the bottle needle 60 is inserted into the discharge port 53 and the engagement claws 65a, 65b go over the engagement portions 26a, 26b, and the inclination of the tip end portions of the engagement claws 65a, 65b abut on back projection portions of the finger placement portions 29a, 29b. This prevents the bottle needle 60 from being inserted excessively into the discharge port 53. Moreover, the front edge of the frame body 11 in which the engagement portions 26a, 26b are formed abuts on a flange portion 64 of the bottle needle 60 to also prevent the excessive insertion of the bottle needle 60 into the discharge port 53. Note that in the fixing jig 10 of the first embodiment, too, the engagement portions 26a, 26b and the discharge port support plates 23a, 23b can be adjusted to be used as means to prevent over insertion of the bottle needle.

While the fixing jig 100 of the second embodiment holds the bag 50 by the base portions 13a, 13b so that it does not move, edges protruding toward the inside of the frame body 11 may be provided in the opening portions 15a, 15b, for example, to hold the bag 50.

Instead of holding the entire bag 50, the fixing jig 100 may be configured to hold only a part of the bag 50 and hold only the discharge port 53. Specifically, any configuration can be adopted as long as the reduced diameter portion (first engaged portion) 55 of the discharge port 53 is sandwiched and held by recesses (first engagement portion) 23c, 23d of discharge port support plates 23a, 23b, and the engagement portions (second engagement portion) 26a, 26b of the frame body 11 engage with engagement claws (second engaged portion) 65a, 65b of the bottle needle 60. Since the fixing jig 100 is made of a harder material than the discharge port 53, when the discharge port 53 is attached, the recesses (first engagement portion) 23c, 23d of the discharge port support plates 23a, 23b and the engagement portions (second engagement portion) 26a, 26b can prevent the bottle needle 60 from being removed from the discharge port 53.

As illustrated in FIG. 7A, the fixing jig 100 of the second embodiment has triangular portions 30a, 30b in the first frame body 11a and the second frame body 11b, respectively. The triangular portions 30a, 30b are provided corresponding to triangular-shaped cutout portions of the bag 50, making it easy to check the orientation of the bag 50 when placing the bag 50 in the frame body 11. However, the triangular portions 30a, 30b are not always necessary.

The fixing jigs 10, 100 described above are configured such that the frame body 11 is openable and closable, but the invention is not limited to this. For example, a wall on one side in the horizontal direction of the frame body 11 may be open, and the discharge port 53 may be slid and attached from the open side. In this case, the frame body 11 is provided with the discharge port support plates 23a, 23b with a gap between them inside the frame body 11 where the discharge port 53 is attached, and the reduced diameter portion 55 of the discharge port 53 is attached by sliding it along end surfaces of the discharge port support plates 23a and 23b. The discharge port 53 may be fixed firmly by narrowing the gap between the discharge port support plates 23a, 23b at the position where the discharge port 53 is fixed. Alternatively, the bag can be slid from the side of the bag and held in the fixing jig, or a part of the fixing jig can be made into an elastic member to enclose the bag and hold it by elastic force. The jig may hold a part of the bag, or may hold only the port. The engagement structure of the fixing jig and the bottle needle is not limited to the locking claw, and may be a physical fit utilizing a protrusion and a recess, a spiral fit, or the like. The configuration of the fixing jig is not limited to the above, as a matter of course.

Note that the present invention is not limited to the above-described embodiments and modifications thereof, and various changes and improvements are of course possible within the scope of the matters described in the claims of the present application.

### REFERENCE SIGNS LIST

10, 100 Fixing jig, 11 Frame body, 11a First frame body, 11b Second frame body, 12 Hinge portion, 13a, 13b Base portion, 15a, 15b Opening portion, 16a, 16b Beam portion, 17 Front wall, 18 Discharge port connection opening, 19 Filler port connection opening, 20 Hook, 20a Tip end portion, 21 Back wall, 22 Hanging portion, 23a, 23b Discharge port support plate, 23c, 23d, 23e, 23f Recess, 24 Locking hole, 25 Locking projection, 26a, 26b Engagement portion, 26c, 26d Window portion, 27a, 27e Locking claw, 27b, 27f Claw portion, 27c, 27g Wall portion, 27d, 27h Side wall portion, 28a, 28c Locking window, 28b, 28d Window portion, 29a, 29b Finger placement portion, 30a, 30b Triangular portion, 50 Bag, 51 Body portion, 52 Joint portion, 53 Discharge port, 54 Tip end, 55 Reduced diameter portion, 56 Filler port, 57 Protection sheet, 60 Bottle needle, 61 Tip end portion, 62 Male connector portion, 63 Torso portion, 64 Flange portion, 65a, 65b Engagement claw

1. A fixing jig for holding a bag including a discharge port, the fixing jig comprising
a frame body capable of holding the bag, wherein
the frame body has an engagement portion that engages with a bottle needle connected to the discharge port and maintains a connected state of the bottle needle.

2. The fixing jig according to claim 1, wherein the frame body further includes a hanging portion.

3. The fixing jig according to claim 1, wherein the frame body includes an opening portion that exposes the bag.

4. The fixing jig according to claim 1, wherein
the frame body is configured to be openable and closable, and further includes a locking structure that maintains a state of closing the frame body and holding the bag.

5. The fixing jig according to claim 1, wherein
the frame body includes over insertion prevention means that prevents excessive insertion of the bottle needle by abutting with a part of the bottle needle when the bottle needle is inserted into the discharge port.

6. A fixing jig attached to a discharge port in which a separation wall is formed integrally with a tubular inner portion or a discharge port provided in a freezer bag for freeze-preservation, the fixing jig comprising
a first engagement portion that is formed to be harder than the discharge port, is attachable to the discharge port, and is capable of engaging with a first engaged portion formed in the discharge port during attachment of the discharge port, and a second engagement portion that is capable of engaging with a second engaged portion formed in a bottle needle, wherein
the bottle needle is prevented from coming off the discharge port by the first engagement portion and the second engagement portion

7. The fixing jig according to claim 6, further comprising:
a frame body configured to be openable and closable; and
a locking structure that closes the frame body and holds the discharge port.
